(19) United States
(12) Patent Application Publication
(10) Pub. No.: US 2020/0269499 A1
(43) Pub. Date: Aug. 27, 2020

(54) ADDITIVE MANUFACTURING USING GROWTH BUILD WALL HEAT PASSAGEWAYS

(71) Applicant: General Electric Company, Schenectady, NY (US)

(72) Inventor: Justin Mamrak, Loveland, OH (US)

(21) Appl. No.: 16/761,595

(22) PCT Filed: Nov. 2, 2018
(86) PCT No.: PCT/US2018/058821

§ 371 Date: May 5, 2020

Related U.S. Application Data
(60) Provisional application No. 62/584,162, filed on Nov. 10, 2017.

(51) Int. Cl. B29C 64/153; B29C 64/364; B29C 64/245; B29C 64/232

(52) U.S. Cl. CPC B29C 64/153; B29C 64/364; B33Y 10/00; B29C 64/232; B29C 64/245

(57) ABSTRACT

Methods are generally provided for making an object(s) from powder. In one embodiment, the method includes: (a) applying a layer of powder on a build platform; (b) irradiating at least part of a layer of powder to form a build wall defining at least one internal cavity therein; (c) moving at least one of the build platform downward or the build unit upward in a direction substantially normal to the layer of powder; and (d) repeating at least steps (a) through (c) to form the build wall. The build wall defines at least one passageway therein, and wherein the at least one passageway has an inlet and an outlet defined in the layer of powder.

### PRIORITY INFORMATION

The present application claims priority to U.S. Provisional Patent Application Ser. No. 62/584,162 titled “Additive Manufacturing Using Growth Build Wall Heat Passageways” filed on Nov. 10, 2017, the disclosure of which is incorporated by reference herein.

### FIELD

The present disclosure generally relates to methods and systems adapted to perform additive manufacturing (“AM”) processes, for example by direct melt laser manufacturing (“DMLM”), on a larger scale format.

### BACKGROUND

Additive manufacturing (“AM”) processes generally involve the buildup of one or more materials to make a net or near net shape (NNS) object, in contrast to subtractive manufacturing methods. Though “additive manufacturing” is an industry standard term (ISO/ASTM52900), AM encompasses various manufacturing and prototyping techniques known under a variety of names, including freeform fabrication, 3D printing, rapid prototyping/tooling, etc. AM techniques are capable of fabricating complex components from a wide variety of materials. Generally, a freestanding object can be fabricated from a computer aided design (CAD) model. A particular type of AM process uses an irradiation emission directing device that directs an energy beam, for example, an electron beam or a laser beam, to sinter or melt a powder material, creating a solid three-dimensional object in which particles of the powder material are bonded together. Different material systems, for example, engineering plastics, thermoplastic elastomers, metals, and ceramics are in use. Laser sintering or melting is a notable AM process for rapid fabrication of functional prototypes and tools. Applications include direct manufacturing of complex workpieces, patterns for investment casting, metal molds for injection molding and die casting, and molds and cores for sand casting. Fabrication of prototype objects to enhance communication and testing of concepts during the design cycle are other common usages of AM processes.

Selective laser sintering, direct laser sintering, selective laser melting, and direct laser melting are common industry terms used to refer to producing three-dimensional (3D) objects by using a laser beam to sinter or melt a fine powder. More accurately, sintering entails fusing (agglomerating) particles of a powder at a temperature below the melting point of the powder material, whereas melting entails fully melting particles of a powder to form a solid homogeneous mass. The physical processes associated with laser sintering or laser melting include heat transfer to a powder material and then either sintering or melting the powder material. Although the laser sintering and melting processes can be applied to a broad range of powder materials, the scientific and technical aspects of the production route, for example, sintering or melting rate and the effects of processing parameters on the microstructural evolution during the layer manufacturing process have not been well understood. This method of fabrication is accompanied by multiple modes of heat, mass and momentum transfer, and chemical reactions that make the process very complex.

During direct metal laser sintering (“DMLS”) or direct metal laser melting (DMLM), an apparatus builds objects in a layer-by-layer manner by sintering or melting a powder material using an energy beam. The powder to be melted by the energy beam is spread evenly over a powder bed on a build platform, and the energy beam sinters or melts a cross sectional layer of the object being built under control of an irradiation emission directing device. The build platform is lowered and another layer of powder is spread over the powder bed and object being built, followed by successive melting/sintering of the powder. The process is repeated until the part is completely built up from the melted/sintered powder material.

After fabrication of the part is complete, various post-processing procedures may be applied to the part. Post processing procedures include removal of excess powder by, for example, blowing or vacuuming. Other post processing procedures include a stress release process. Additionally, thermal and chemical post processing procedures can be used to finish the part.

In conventional systems, the walls of the powder bed define the amount of powder needed to make a part. The weight of the powder within the build environment is one limitation on the size of parts being built in this type of apparatus. The amount of powder needed to make a large part may exceed the limits of the build platform or make it difficult to control the lowering of the build platform by precise steps which is needed to make highly uniform additive layers in the object being built.

Additionally, the thermal state of the build environment is not well controlled in conventional systems. In most cases, this variable constitutes a negative impact on the subject build attributes and, if nothing else, is a direct contributor to variability exhibited as part to part differences related to thermally driven deformation and adverse quality and process build difficulties. In addition, these thermal effects are magnified as the build platform is increased. As such, there remains a need for an improved large format powder manufacturing system, along with methods of its use.

### BRIEF DESCRIPTION

Aspects and advantages will be set forth in part in the following description, or may be obvious from the description, or may be learned through practice of the invention.

Methods are generally provided for making an object(s) from powder. In one embodiment, the method includes: (a) applying a layer of powder on a build platform; (b) irradiating at least part of a layer of powder to form a build wall defining at least one internal cavity therein; (c) moving at least one of the build platform downward or the build unit upward in a direction substantially normal to the layer of powder; and (d) repeating at least steps (a) through (c) to form the build wall. The build wall defines at least one passageway therein, and wherein the at least one passageway has an inlet and an outlet defined in the layer of powder.

In one embodiment, the method for making an object from powder may include: (a) applying a layer of powder on a build platform; (b) irradiating at least part of a layer of powder to form a build envelope defining at least two internal cavities therein, with a first cavity located on an inlet defined within the build platform and a second cavity located on an outlet defined within the build platform; (c) moving at least one of the build envelope downward or the build unit upward in a direction substantially normal to the layer of powder; (d) applying another layer of powder on the build platform; (e) irradiating at least part of a layer of powder to form a build envelope defining a successive first cavity and a successive second cavity therein, wherein the first and second cavities align with the first and second cavities of the underlying build envelope; and (f) repeating at least steps (c) through (e) to form the build envelope, wherein the internal first and second cavities of the successive layers of the build wall are aligned with each other to eventually define a first passageway during the build process.

An additive manufacturing apparatus is also provided. In one embodiment, the additive manufacturing apparatus may include: a build platform defining at least one inlet and at least one outlet therein; a build unit positioned over the build platform, wherein the build unit comprises a powder dispenser and a recoater blade; an irradiation emission directing device; and a positioning system to which the build unit is attached. For example, the positioning system may be adapted to move the build unit in at least three dimensions during operation.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended Figs., in which:

FIG. 1 shows a large scale additive manufacturing apparatus according to an embodiment of the invention;

FIG. 2 shows a side view of a build unit according to an embodiment of the invention;

FIG. 3 shows a side view of a build unit dispensing powder according to an embodiment of the invention;

FIG. 4 shows a top view of a build unit according to an embodiment of the invention;

FIG. 5 shows a top view of a recoater according to an embodiment of the present invention;

FIG. 6 illustrates a large scale additive manufacturing apparatus with two build units according to an embodiment of the present invention;

FIGS. 7A-7C illustrate embodiments of a system and process of building an object within a build area that includes a build envelope according to an embodiment of the invention;

FIG. 8 shows a top down view of a system and process of building an object within a build area that includes a build envelope and inner columns according to an embodiment of the invention;

FIG. 9 shows an exemplary fluid flow system for use with a system and process of building an object according to an embodiment of the invention;

FIG. 10 shows an exemplary control system for use with the system and process of building an object according to an embodiment of the invention; and

FIG. 11 shows a diagram of an exemplary method of one embodiment of the present invention.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Methods and apparatus are generally provided for additive manufacturing objects on a build platform, while simultaneously building a build walls that collectively form build envelope. Generally, the build envelope is formed so that a first build area, where the object(s) can be formed, is defined within the build envelope's boundaries. During the build process, at least one passageway is formed within the build walls of the build envelope spanning from an inlet to an outlet of the first layer or powder adjacent to the build platform. In an effort to maintain thermal control and stability of the growth environment, the passageway(s) within the build walls can be utilized as a heat exchanger by flowing fluids therethrough. As such, the temperature of the powder bed and objects therein can be better regulated to mitigate or prevent cracking, distortion, or other issues stemming from thermal gradients. In one embodiment, the inlets and outlets of each passageway may be built over specific locations on the build platform that have powder and air handling fittings in the platform. As the cavities are completed (i.e., enclosed) during the build process, these inlets and outlets may open and allow powder out to define the passageway, through which hot air may be vented and/or cooling fluid can be flowed through.

As such, an apparatus is provided that can be used to perform additive manufacturing, as well as methods for utilizing the apparatus to additively manufacture objects. The apparatus includes components that make it particularly useful for making large additively manufactured objects through thermal management of the build area. In one particular embodiment, a build unit may be used to include several components necessary for making high precision, large scale additively manufactured objects, which may include, for example, a recoater, a gasflow device with a gasflow zone, and an irradiation emission directing device. An irradiation emission directing device used in an embodiment of the present invention may be, for example, an optical control unit for directing a laser beam. An optical control unit may comprise, for example, optical lenses, deflectors, mirrors, and/or beam splitters. Advantageously, a telecentric lens may be used. Alternatively, the irradiation emission directing device may be an electronic control unit for directing an e-beam. The electronic control unit may comprise, for example, deflector coils, focusing coils, or similar elements. The build unit may be attached to a positioning system (e.g. a gantry, delta robot, cable robot, robot arm, belt drive, etc.) that allows three dimensional movement throughout a build environment, as well as rotation of the build unit in a way that allows coating of a thin powder layer in any direction desired.

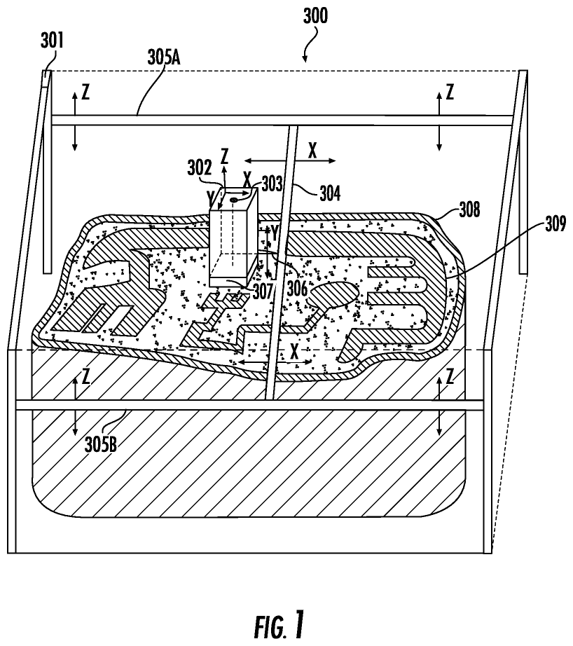

FIG. 1 shows an example of one embodiment of a large-scale additive manufacturing apparatus 300 according to the present invention. The apparatus 300 comprises a positioning system 301, a build unit 302 comprising an irradiation emission directing device 303, a laminar gas flow zone 307, and a build plate (not shown in this view) beneath an object being built 309. The maximum build area is defined by the positioning system 301, instead of by a powder bed as with conventional systems, and the build area for a particular build can be confined to a build envelope 308 that may be dynamically built up along with the object. The positioning system 301 in the embodiment shown is a gantry having an x crossbeam 304 that moves the build unit 302 in the x direction. There are two z crossbeams 305A and 305B that move the build unit 302 and the x crossbeam 304 in the z direction. The x cross beam 304 and the build unit 302 are attached by a mechanism 306 that moves the build unit 302 in the y direction. In this illustration of one embodiment of the invention, the positioning system 301 is a gantry, but the present invention is not limited to using a gantry. In general, the positioning system used in the present invention may be any multidimensional positioning system such as a delta robot, cable robot, robot arm, etc. The irradiation emission directing device 303 may be independently moved inside of the build unit 302 by a second positioning system (not shown). The atmospheric environment outside the build unit, i.e. the “build environment,” or “containment zone,” is typically controlled such that the oxygen content is reduced relative to typical ambient air, and so that the environment is at reduced pressure.

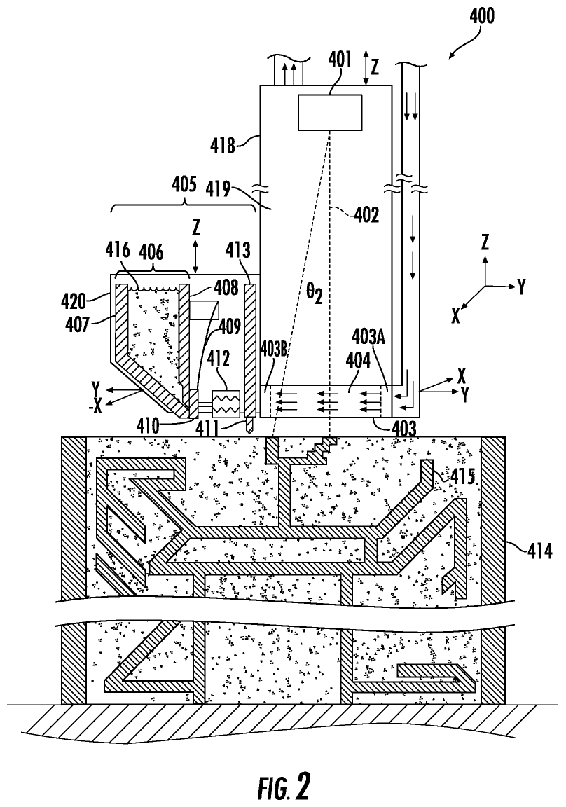

There may also be an irradiation source that, in the case of a laser source, originates the photons comprising the laser beam irradiation is directed by the irradiation emission directing device. When the irradiation source is a laser source, then the irradiation emission directing device may be, for example, a galvo scanner, and the laser source may be located outside the build environment. Under these circumstances, the laser irradiation may be transported to the irradiation emission directing device by any suitable means, for example, a fiber-optic cable. When the irradiation source is an electron source, then the electron source originates the electrons that comprise the e-beam that is directed by the irradiation emission directing device. When the irradiation source is an electron source, then the irradiation emission directing device may be, for example, a deflecting coil. When a large-scale additive manufacturing apparatus according to an embodiment of the present invention is in operation, if the irradiation emission directing devices directs a laser beam, then generally it is advantageous to include a gasflow device providing substantially laminar gas flow to a gasflow zone as illustrated in FIG. 1, 307 and FIG. 2, 404. If an e-beam is desired, then no gasflow is provided. An e-beam is a well-known source of irradiation. When the source is an electron source, then it is important to maintain sufficient vacuum in the space through which the e-beam passes. Therefore, for an e-beam, there is no gas flow across the gasflow zone (shown, for example at FIG. 1, 307).

The apparatus 300 allows for a maximum angle of the beam to be a relatively small angle θ₂ to build a large part, because (as illustrated in FIG. 1) the build unit 302 can be moved to a new location to build a new part of the object being formed 309. When the build unit is stationary, the point on the powder that the energy beam touches when θ₂ is 0 defines the center of a circle in the xy plane (the direction of the beam when θ₂ is approximately 0 defines the z direction), and the most distant point from the center of the circle where the energy beam touches the powder defines a point on the outer perimeter of the circle. This circle defines the beam's scan area, which may be smaller than the smallest cross sectional area of the object being formed (in the same plane as the beam's scan area). There is no particular upper limit on the size of the object relative to the beam's scan area.

In some embodiments, the recoater used is a selective recoater. One embodiment is illustrated in FIGS. 2 through 5.

FIG. 2 shows a build unit 400 comprising an irradiation emission directing device 401, a gasflow device 403 with a pressurized outlet portion 403A and a vacuum inlet portion 403B providing gas flow to a gasflow zone 404, and a recoater 405. Above the gasflow zone 404 there is an enclosure 418 containing an inert environment 419. The recoater 405 has a hopper 406 comprising a back plate 407 and a front plate 408. The recoater 405 also has at least one actuating element 409, at least one gate plate 410, a recoater blade 411, an actuator 412, and a recoater arm 413. The recoater is mounted to a mounting plate 420. FIG. 2 also shows a build envelope 414 that may be built by, for example, additive manufacturing or Mig/Tig welding, an object being formed 415, and powder 416 contained in the hopper 405 used to form the object 415. In this particular embodiment, the actuator 412 activates the actuating element 409 to pull the gate plate 410 away from the front plate 408. In an embodiment, the actuator 412 may be, for example, a pneumatic actuator, and the actuating element 409 may be a bidirectional valve. In an embodiment, the actuator 412 may be, for example, a voice coil, and the actuating element 409 may be a spring. There is also a hopper gap 417 between the front plate 408 and the back plate 407 that allows powder to flow when a corresponding gate plate is pulled away from the powder gate by an actuating element. The powder 416, the back plate 407, the front plate 408, and the gate plate 410 may all be the same material. Alternatively, the back plate 407, the front plate 408, and the gate plate 410 may all be the same material, and that material may be one that is compatible with the powder material, such as cobalt-chrome. In this particular embodiment, the gas flow in the gasflow zone 404 flows in the y direction, but it does not have to. The recoater blade 411 has a width in the x direction. The direction of the irradiation emission beam when θ₂ is approximately 0 defines the z direction in this view. The gas flow in the gasflow zone 404 may be substantially laminar. The irradiation emission directing device 401 may be independently movable by a second positioning system (not shown). FIG. 2 shows the gate plate 410 in the closed position.

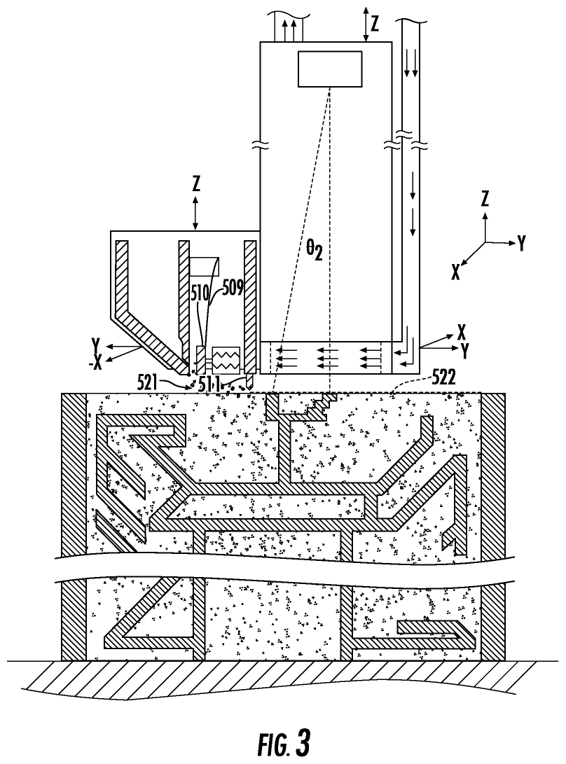

FIG. 3 shows the build unit of FIG. 2, with the gate plate 410 in the open position (as shown by element 510) and actuating element 509. Powder in the hopper is deposited to make fresh powder layer 521, which is smoothed over by the recoater blade 511 to make a substantially even powder layer 522. In some embodiments, the substantially even powder layer may be irradiated at the same time that the build unit is moving, which would allow for continuous operation of the build unit and thus faster production of the object.

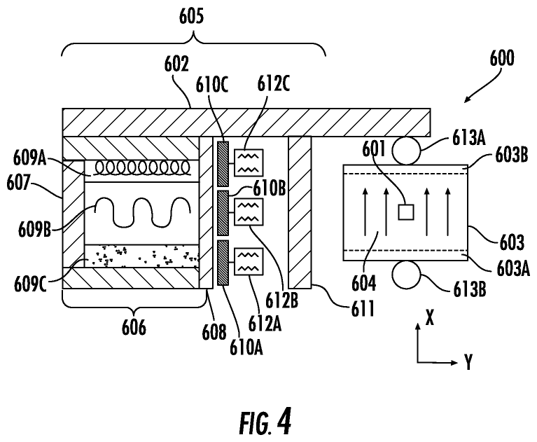

FIG. 4 shows a top down view of the build unit of FIG. 2. For simplicity, the object and the walls are not shown here. The build unit 600 has an irradiation emission directing device 601, an attachment plate 602 attached to the gasflow device 603, hopper 606, and recoater arm 611. The gasflow device has a gas outlet portion 603A and a gas inlet portion 603B. Within the gasflow device 603 there is a gasflow zone 604. The gasflow device 603 provides laminar gas flow within the gasflow zone 604. There is also a recoater 605 with a recoater arm 611, actuating elements 612A, 612B, and 612C, and gate plates 610A, 610B, and 610C. The recoater 605 also has a hopper 606 with a back plate 607 and front plate 608. In this particular illustration of one embodiment of the present invention, the hopper is divided into three separate compartments containing three different materials 609A, 609B, and 609C. There are also gas pipes 613A and 613B that feed gas out of and into the gasflow device 603.

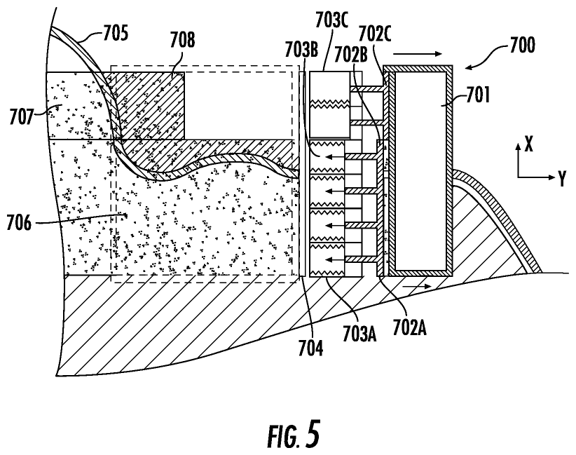

FIG. 5 shows a top down view of a recoater according to one embodiment, where the recoater has a hopper 700 with only a single compartment containing a powder material 701. There are three gate plates 702A, 702B, and 702C that are controlled by three actuating elements 703A, 703B, and 703C. There is also a recoater arm 704 and a wall 705. When the recoater passes over a region that is within the wall, such as indicated by 707, the corresponding gate plate 702C may be held open to deposit powder in that region 707. When the recoater passes over a region that is outside of the wall, such as the region indicated as 708, the corresponding gate plate 702C is closed by its corresponding actuating element 703C, to avoid depositing powder outside the wall, which could potentially waste the powder. Within the wall 705, the recoater is able to deposit discrete lines of powder, such as indicated by 706. The recoater blade (not shown in this view) smooths out the powder deposited.

Advantageously, a selective recoater according to embodiments of the apparatus and methods described herein allows precise control of powder deposition using powder deposition device (e.g. a hopper) with independently controllable powder gates as illustrated, for example, in FIG. 4, 606, 610A, 610B, and 610C and FIG. 5, 702A, 702B, and 702C. The powder gates are controlled by at least one actuating element which may be, for instance, a bidirectional valve or a spring (as illustrated, for example, in FIG. 2, 409. Each powder gate can be opened and closed for particular periods of time, in particular patterns, to finely control the location and quantity of powder deposition (see, for example, FIG. 4). The hopper may contain dividing walls so that it comprises multiple chambers, each chamber corresponding to a powder gate, and each chamber containing a particular powder material (see, for example, FIG. 4, and 609A, 609B, and 609C). The powder materials in the separate chambers may be the same, or they may be different. Advantageously, each powder gate can be made relatively small so that control over the powder deposition is as fine as possible. Each powder gate has a width that may be, for example, no greater than about 2 inches, or more preferably no greater than about ¼ inch. In general, the smaller the powder gate, the greater the powder deposition resolution, and there is no particular lower limit on the width of the powder gate. The sum of the widths of all powder gates may be smaller than the largest width of the object, and there is no particular upper limit on the width of the object relative to the sum of the widths of the power gates. Advantageously, a simple on/off powder gate mechanism according to one embodiment is simpler and thus less prone to malfunctioning. It also advantageously permits the powder to come into contact with fewer parts, which reduces the possibility of contamination. Advantageously, a recoater according to an embodiment of the present invention can be used to build a much larger object. For example, the largest xy cross sectional area of the recoater may be smaller than the smallest cross sectional area of the object, and there is no particular upper limit on the size of the object relative to the recoater. Likewise, the width of the recoater blade may be smaller than the smallest width of the object, and there is no particular upper limit on the width of the object relative to the recoater blade. After the powder is deposited, a recoater blade can be passed over the powder to create a substantially even layer of powder with a particular thickness, for example about 50 micrometers (microns or “μm”) or less (e.g., about 10 microns to about 50 microns), such as about 30 microns or less (e.g., about 15 microns to about 25 microns, such as about 20 microns). Another feature of some embodiments of the present invention is a force feedback loop. There can be a sensor on the selective recoater that detects the force on the recoater blade. During the manufacturing process, if there is a time when the expected force on the blade does not substantially match the detected force, then control over the powder gates may be modified to compensate for the difference. For instance, if a thick layer of powder is to be provided, but the blade experiences a relatively low force, this scenario may indicate that the powder gates are clogged and thus dispensing powder at a lower rate than normal. Under these circumstances, the powder gates can be opened for a longer period of time to deposit sufficient powder. On the other hand, if the blade experiences a relatively high force, but the layer of powder provided is relatively thin, this may indicate that the powder gates are not being closed properly, even when the actuators are supposed to close them. Under these circumstances, it may be advantageous to pause the build cycle so that the system can be diagnosed and repaired, so that the build may be continued without comprising part quality. Another feature of some embodiments of the present invention is a camera for monitoring the powder layer thickness. Based on the powder layer thickness, the powder gates can be controlled to add more or less powder.

In addition, an apparatus according to an embodiment of the present invention may have a controlled low oxygen build environment with two or more gas zones to facilitate a low oxygen environment. The first gas zone is positioned immediately over the work surface. The second gas zone may be positioned above the first gas zone, and may be isolated from the larger build environment by an enclosure. For example, in FIG. 2 element 404 constitutes the first gas zone, element 419 constitutes the second gas zone contained by the enclosure 418, and the environment around the entire apparatus is the controlled low oxygen build environment. In the embodiment illustrated in FIG. 2, the first gasflow zone 404 is essentially the inner volume of the gasflow device 403, i.e. the volume defined by the vertical (xz plane) surfaces of the inlet and outlet portions (403A and 403B), and by extending imaginary surfaces from the respective upper and lower edges of the inlet portion to the upper and lower edges of the outlet portion in the xy plane. When the irradiation emission directing device directs a laser beam, then the gasflow device preferably provides substantially laminar gas flow across the first gas zone. This facilitates removal of the effluent plume caused by laser melting. Accordingly, when a layer of powder is irradiated, smoke, condensates, and other impurities flow into the first gasflow zone, and are transferred away from the powder and the object being formed by the laminar gas flow. The smoke, condensates, and other impurities flow into the low-pressure gas outlet portion and are eventually collected in a filter, such as a HEPA filter. By maintaining laminar flow, the aforementioned smoke, condensates and other impurities can be efficiently removed while also rapidly cooling melt pool(s) created by the laser, without disturbing the powder layer, resulting in higher quality parts with improved metallurgical characteristics. In an aspect, the gas flow in the gasflow volume is at about 3 meters per second. The gas may flow in either the x or y direction.

The oxygen content of the second controlled atmospheric environment is generally approximately equal to the oxygen content of the first controlled atmospheric environment, although it doesn't have to be. The oxygen content of both controlled atmospheric environments is preferably relatively low. For example, it may be 1% or less, or more preferably 0.5% or less, or still more preferably 0.1% or less. The non-oxygen gases may be any suitable gas for the process. For instance, nitrogen obtained by separating ambient air may be a convenient option for some applications. Some applications may use other gases such as helium, neon, or argon. An advantage of the invention is that it is much easier to maintain a low-oxygen environment in the relatively small volume of the first and second controlled atmospheric environments. In prior art systems and methods, the larger environment around the entire apparatus and object must be tightly controlled to have a relatively low oxygen content, for instance 1% or less. This can be time-consuming, expensive, and technically difficult. Thus it is preferable that only relatively smaller volumes require such relatively tight atmospheric control. Therefore, in the present invention, the first and second controlled atmospheric environments may be, for example, 100 times smaller in terms of volume than the build environment. The first gas zone, and likewise the gasflow device, may have a largest xy cross sectional area that is smaller than the smallest cross sectional area of the object. There is no particular upper limit on the size of the object relative to the first gas zone and/or the gasflow device. Advantageously, the irradiation emission beam (illustrated, for example, as 402 and 502) fires through the first and second gas zones, which are relatively low oxygen zones. And when the first gas zone is a laminar gasflow zone with substantially laminar gas flow, the irradiation emission beam is a laser beam with a more clear line of sight to the object, due to the aforementioned efficient removal of smoke, condensates, and other contaminants or impurities.

One advantage of the present invention is that, in some embodiments, the build plate may be vertically stationary (i.e. in the z direction). This permits the build plate to support as much material as necessary, unlike the prior art methods and systems, which require some mechanism to raise and lower the build plate, thus limiting the amount of material that can be used. Accordingly, the apparatus of the present invention is particularly suited for manufacturing an object within a large (e.g., greater than 1 m³) build envelope. For instance, the build envelope may have a smallest xy cross sectional area greater than 500 mm², or preferably greater than 750 mm², or more preferably greater than 1 m². The size of the build envelope is not particularly limited. For instance, it could have a smallest cross sectional area as large as 100 m². Likewise, the formed object may have a largest xy cross sectional area that is no less than about 500 mm², or preferably no less than about 750 mm², or still more preferably no less than about 1 m². There is no particular upper limit on the size of the object. For example, the object's smallest xy cross sectional area may be as large as 100 m². Because the build envelope retains unfused powder about the object, it can be made in a way that minimizes unfused powder (which can potentially be wasted powder) within a particular build, which is particularly advantageous for large builds. When building large objects within a dynamically grown build envelope, it may be advantageous to build the envelope using a different build unit, or even a different build method altogether, than is used for the object. For example, it may be advantageous to have one build unit that directs an e-beam, and another build unit that directs a laser beam. With respect to the build envelope, precision and quality of the envelope may be relatively unimportant, such that rapid build techniques are advantageously used. In general, the build envelope may be built by any suitable means, for instance by Mig or Tig welding, or by laser powder deposition. If the wall is built by additive manufacturing, then a different irradiation emission directing device can be used to build than wall than is used to build the object. This is advantageous because building the wall may be done more quickly with a particular irradiation emission directing device and method, whereas a slower and more accurate directing device and method may be desired to build the object. For example, the wall may be built from a rapidly built using a different material from the object, which may require a different build method. Ways to tune accuracy vs. speed of a build are well known in the art, and are not recited here.

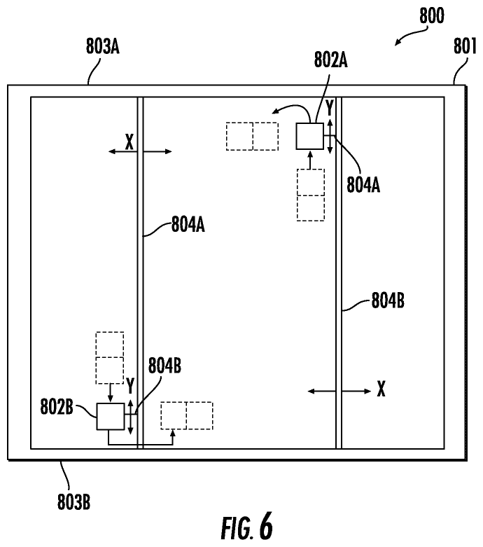

For example, as shown in FIG. 6, the systems and methods of the present invention may use two or more build units to build one or more object(s). The number of build units, objects, and their respective sizes are only limited by the physical spatial configuration of the apparatus. FIG. 6 shows a top down view of a large-scale additive manufacturing machine 800 according to an embodiment of the invention. There are two build units 802A and 802B mounted to a positioning system 801. There are z crossbeams 803A and 803B for moving the build units in the z direction. There are x crossbeams 804A and 804B for moving the build units in the x direction. The build units 802A and 802B are attached to the x crossbeams 804A and 804B by mechanisms 805A and 805B that move the units in the y direction. The object(s) being formed are not shown in this view. A build envelope (also not shown in this view) can be built using one or both of the build units, including by laser powder deposition. The build envelope could also be built by, e.g., welding. In general, any number of objects and build envelopes can be built simultaneously using the methods and systems of the present invention.

Advantageously, in some embodiments of the present invention the wall may be built up around the object dynamically, so that its shape follows the shape of the object. A dynamically built chamber wall advantageously results in the chamber wall being built closer to the object, which reduces the size of support structures required, and thus reduces the time required to build the support structures. Further, smaller support structures are more stable and have greater structural integrity, resulting in a more robust process with less failure. In one embodiment, two build envelopes may be built, one concentric within the other, to build objects in the shape of, for example, circles, ovals, and polygons. If the wall is built by welding, then support structures such as buttresses may be advantageously built on the wall as needed, to support overhangs and other outwardly-built features of the object. Therefore, according to an embodiment of the present invention, a dynamically built chamber wall enables object features that would be either impossible or impractical using conventional technology.

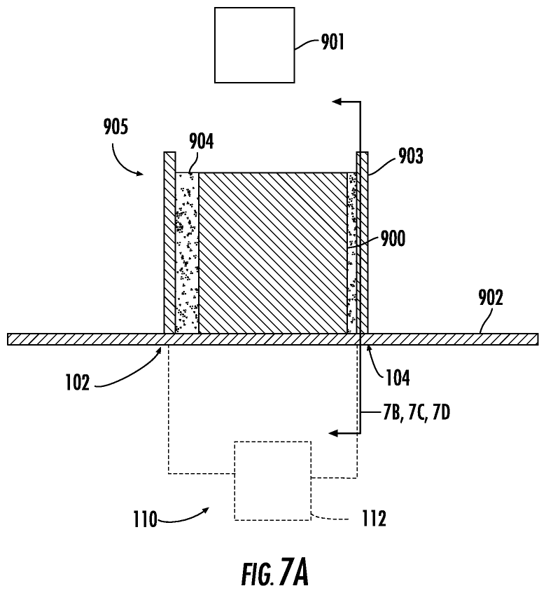

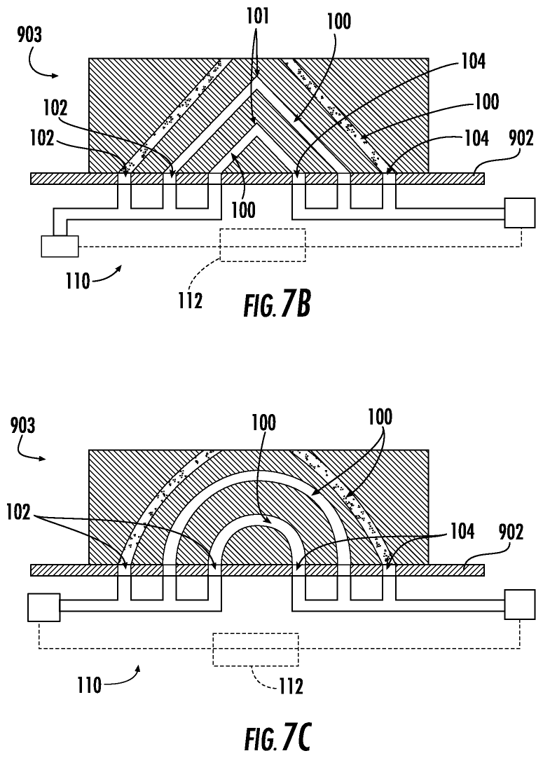

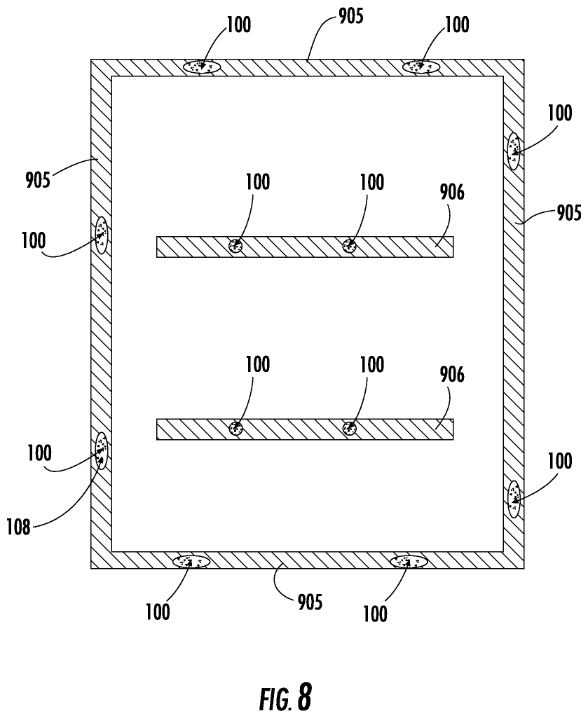

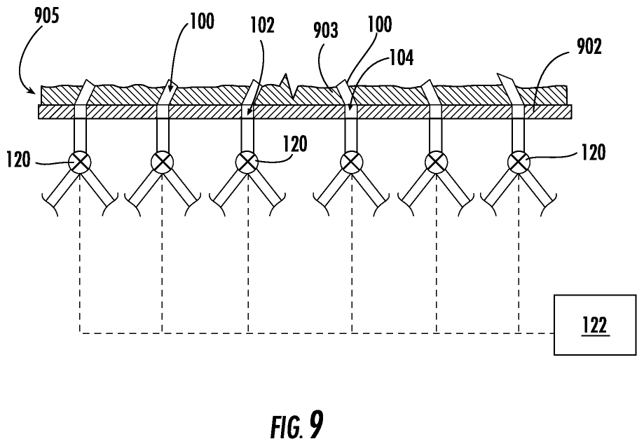

FIG. 7A illustrates an object built vertically upward from powder, within a dynamically grown build envelope, on a vertically stationary build plate according to one embodiment. In this embodiment, the object 900 is built on a vertically stationary build plate 902 using a build unit 901. Since the build unit 901 may be capable of selectively dispensing powder within the build envelope 905 defined within build walls 903, the unfused deposited powder 904 is generally entirely within the build envelope 905, or at least a substantial portion of the unfused deposited powder 904 stays within the build envelope 905. After the build, the build unit 901 may be moved away from the object 900 to more easily access the object 900. Mobility of the of the build unit 901 may be enabled by, for instance, a positioning system (not shown in this view).

As better shown in the cross-sectional view of the build walls 903 of the build envelope 903 of FIGS. 7B and 7C, the passageways 100 are formed during the build such that each passageway 100 has an inlet 102 and an outlet 104, with any suitable shape formed by the passageways 100 therebetween. For example, the embodiment of FIG. 7B shows that the passageways 100 are defined by two substantially straight channels joined at an interface connection 101 (e.g., an apex connection, a bridge connection, etc.), with multiple passageways 100 nested with each other. As another exemplary embodiment, FIG. 7C shows that the passageways 100 form an arch from the inlet to the outlet, with multiple passageways 100 nested with each other.

During formation, the passageways 100 are formed by layer-by-layer deposition, with the passageway formed within the build wall 905 by irradiating the entire area of the build wall 905 but for the portion defining the passageway 100. As such, loose powder material 108 is within the passageway 100 during the build of the wall 905. Once the passageway 100 is completed, in the sense that the passageway connects the inlet 102 and the outlet 104 such that the passageway 100 is completely encased within the build wall 905, the loose powder material 108 may be evacuated from within the passageway 100 by opening the inlet 102 and the outlet 104.

In one embodiment, the inlet 102 and outlet 104 may be operably controlled between a closed position and an open position. In the closed position, the inlet 102 and outlet 104 serve as a platform for the passageway 100 during the build process. Then, the inlet 102 and outlet 104 may be actuated to its open position, allowing the passageway 100 to be evacuated so as to remove the loose powder material 108 therein.

No matter the shape of the passageways 100, a flow system 110 may be fluidly connected to the inlet 102 and the outlet 104. The flow system 110 may be configured to collect loose powder material 108 from the passageways 100. In one embodiment, a vacuum source is connected to the inlet 102 and/or the outlet 104 so as to pull the loose powder material 108 from the passageways 100.

Additionally, the flow system 110 may include an open or closed cooling system that is configured to flow a fluid through the passageways 100 to serve as a heat transfer medium. In one embodiment, the fluid may be an inert gas (e.g., nitrogen, argon, etc.), air, water, and/or other suitable organic chemical (e.g., ethylene glycol, diethylene glycol, or propylene glycol). A heat exchanger 112 (e.g., a radiator) may be utilized with the flow system 110 so as to recirculate and control the temperature of the fluid flowing into the inlets 102. Various conduits, pumps, valves, and/or tanks may be included within the flow system 110 as desired.

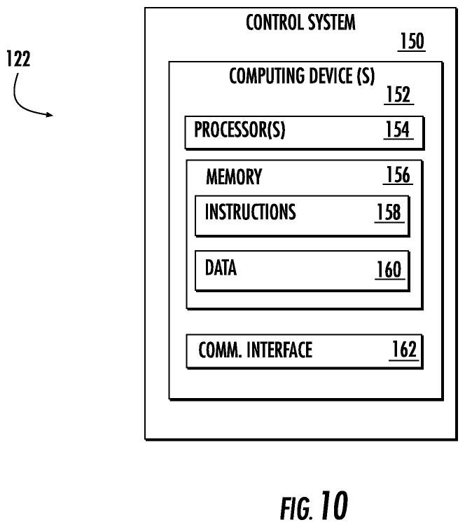

Referring to FIG. 9, a multi-way valve 120 may be fluidly connected to the inlets 102 and/or outlets 104 so as to actuate the inlets 102 and/or outlets 104 between a closed position, an evacuation position (e.g., collecting the loose powder material 108), and a fluid flow position (e.g., connected to the fluid flow system 110). As such, each inlet 102 and outlet 104 may be individually controlled, such as by computing device 122 in communication with each multi-way valve 120.

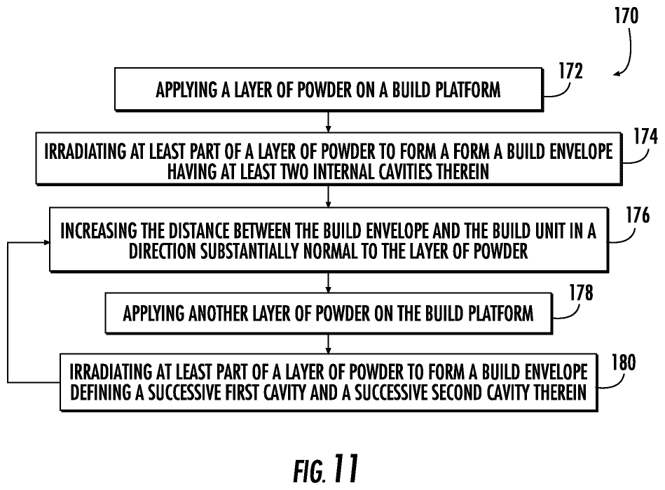

FIG. 10 depicts a block diagram of an example control system 150 that can be used to implement methods and systems according to example embodiments of the present disclosure, particularly the evacuation and/or flow system 110. In one embodiment, the control system 150 may be configured to independently regulate flow of a fluid through individual passageways 100. As shown, the control system 150 can include one or more computing device(s) 152. The one or more computing device(s) 152 can include one or more processor(s) 154 and one or more memory device(s) 156. The one or more processor(s) 154 can include any suitable processing device, such as a microprocessor, microcontroller, integrated circuit, logic device, or other suitable processing device. The one or more memory device(s) 156 can include one or more computer-readable media, including, but not limited to, non-transitory computer-readable media, RAM, ROM, hard drives, flash drives, or other memory devices.

The one or more memory device(s) 156 can store information accessible by the one or more processor(s) 154, including computer-readable instructions 158 that can be executed by the one or more processor(s) 154. The instructions 158 can be any set of instructions that when executed by the one or more processor(s) 154, cause the one or more processor(s) 154 to perform operations. The instructions 158 can be software written in any suitable programming language or can be implemented in hardware. In some embodiments, the instructions 158 can be executed by the one or more processor(s) 154 to cause the one or more processor(s) 154 to perform operations, such as the operations for controlling the actuation of the inlet 102 and/or outlet 104, along with the flow system 110.

The memory device(s) 156 can further store data 160 that can be accessed by the one or more processor(s) 154. For example, the data 160 can include any data used for stabilizing input, as described herein. The data 160 can include one or more table(s), function(s), algorithm(s), model(s), equation(s), etc. for stabilizing input according to example embodiments of the present disclosure.

The one or more computing device(s) 152 can also include a communication interface 162 used to communicate, for example, with the other components of system. The communication interface 162 can include any suitable components for interfacing with one or more network(s), including for example, transmitters, receivers, ports, controllers, antennas, or other suitable components.

FIG. 11 shows a diagram of an exemplary method 170 for making an object from powder. In the embodiment shown, the method includes applying a layer of powder on a build platform at 172. At 174, at least part of the layer of powder is irradiated to form a build envelope defining at least two internal cavities therein, with a first cavity located on an inlet defined within the build platform and a second cavity located on an outlet defined within the build platform. At 176, at least one of the build envelope or the build unit is moved downward or upward, respectively, in a direction substantially normal to the layer of powder. At 178, another layer of powder is applied on the build platform. At 180, at least part of a layer of powder is irradiated to form a build envelope defining a successive first cavity and a successive second cavity therein. The first and second cavities generally align with the first and second cavities of the underlying build envelope. Steps 176, 178, and 180 may then be repeated to form the build envelope, where the internal first and second cavities of the successive layers of the build wall are aligned with each other to eventually define a first passageway during the build process.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for making an object from powder, the method comprising:
(a) applying a layer of powder on a build platform;
(b) irradiating at least part of a layer of powder to form a build wall defining at least one internal cavity therein;
(c) moving at least one of the build platform downward or the build unit upward in a direction substantially normal to the layer of powder; and
(d) repeating at least steps (a) through (c) to form the build wall, wherein the build wall defines at least one passageway therein, and wherein the at least one passageway has an inlet and an outlet defined in the layer of powder.

2. The method of claim 1, wherein multiple build walls are made to form a build envelope around a first build area.

3. The method of claim 1, wherein successive layers of the build wall define cavities adjacent to each other to eventually define the passageway during the build process.

4. The method of claim 1, wherein the inlet of the at least one passageway is in fluid communication with a gas supply through an inlet aperture in the build platform, and wherein the outlet of the at least one passageway is in fluid communication with an outlet aperture in the build platform.

5. The method of claim 4, further comprising:
flowing a fluid through the inlet aperture of the build platform into the inlet of the passageway.

6. The method of claim 5, further comprising:
collecting the fluid from the passageway and the build platform through the outlet.

7. The method of claim 6, further comprising:
cooling the collected fluid from the outlet; and
recirculating the fluid through the passageway of the build envelope.

8. The method of claim 1, wherein the passageway is defined by two substantially straight channels joined at an interface connection.

9. The method of claim 1, wherein the passageway forms an arch from the inlet to the outlet.

10. The method of claim 1, wherein a plurality of passageways are nested on each other so as to form a plurality of independent passageways.

11. The method of claim 1, wherein irradiating at least part of the first layer of powder to form the build envelope around the first build area further comprises:
irradiating at least part of the first layer of powder to form at least one inner column within the first build area such that repeating at least steps (a) through (c) forms the build envelope, an inner column, and the object within the first build area, wherein the at least one inner column defines at least one passageway having an inlet and an outlet defined in the first layer of powder.

12. The method of claim 11, wherein the inlet of the at least one inner column is in fluid communication with a gas supply through an inlet aperture in the build platform, and wherein the outlet of the at least one passageway of the inner column is in fluid communication with an outlet aperture in the build platform.

13. The method of claim 12, further comprising:
flowing a fluid through the inlet aperture into the inlet of the passageway of the build platform.

14. The method of claim 1, further comprising:
upon completing a passageway in the build envelope, opening an aperture in the build platform adjacent to the outlet and/or inlet of the passageway to evacuate the powder therein.

15. A method for making an object from powder, the method comprising:
(a) applying a layer of powder on a build platform;
(b) irradiating at least part of a layer of powder to form a build envelope defining at least two internal cavities therein, with a first cavity located on an inlet defined within the build platform and a second cavity located on an outlet defined within the build platform;
(c) moving at least one of the build envelope downward or the build unit upward in a direction substantially normal to the layer of powder;
(d) applying another layer of powder on the build platform;
(e) irradiating at least part of a layer of powder to form a build envelope defining a successive first cavity and a successive second cavity therein, wherein the first and second cavities align with the first and second cavities of the underlying build envelope; and
(f) repeating at least steps (c) through (e) to form the build envelope, wherein the internal first and second cavities of the successive layers of the build wall are aligned with each other to eventually define a first passageway during the build process.
